(19) United States
(12) Patent Application Publication
(10) Pub. No.: US 2022/0380631 A1
(43) Pub. Date: Dec. 1, 2022

(54) FLEXIBLE TAPE WITH EMBEDDED CUTTING FILAMENT

(71) Applicant: Langeman Manufacturing Limited, Kingsville (CA)

(72) Inventor: Gary D. Langeman, Naples, FL (US)

(21) Appl. No.: 17/626,696

(22) PCT Filed: Jul. 17, 2020
(86) PCT No.: PCT/CA2020/000092

§ 371 Date: Jan. 12, 2022

Related U.S. Application Data
(60) Provisional application No. 62/876,136, filed on Jul. 19, 2019.

(51) Int. Cl. C09J 7/26; B05B 12/24; C09J 7/24; C09J 7/38

(52) U.S. Cl. CPC C09J 7/26; B05B 12/24; C09J 7/243; C09J 7/38; C09J 2203/31; C09J 2301/16; C09J 2301/18; C09J 2301/302; C09J 2301/502

(57) ABSTRACT

The present invention provides a filament-bearing tape. The filament-bearing tape extends longitudinally and comprises a flexible substrate having a first edge and a second edge parallel to the first edge, and having top and bottom surfaces. The tape also has a filament that is encompassed in the top surface of the substrate, parallel to the edges of the substrate.

### FIELD OF THE INVENTION

The present invention relates generally to tape for trimming coatings, such as polyurethane and paint, on surfaces. Specifically the invention relates to filament-bearing tape for trimming coatings, such as polyurethane, paint and epoxies; films such as vinyl and polyester; other various substrates such as paper, cork, felt, etc.

### BACKGROUND OF THE INVENTION

Masking tape is widely used by painters and others applying a coating to a surface in order to define a sharp edge on the portion of the surface being coated. The tape protects a portion of the surface that is not to be coated. Conventional masking tape is longitudinally extended with first and second parallel longitudinal edges and a pressure-sensitive adhesive layer formed on one side of a substrate, or backing. The adhesive layer permits the masking tape to be removably attached to a surface. The coating may then be applied to the surface so that the first longitudinal edge of the masking tape is also covered by the coating. The tape can then be removed, leaving a straight and well defined edge of the portion of the surface that is coated, corresponding to the position of the first longitudinal edge of the tape.

The pressure-sensitive adhesive is selected so that the tape can easily be removed from the surface. The substrate is typically made from paper and is hand-tearable. The tape is typically manufactured in rolls so that a user can unwind a length of tape and then hand-tear it transversely to remove a strip of tape from the roll.

The paper substrate may be saturated with a latex binder and then dried before the adhesive is applied in order to improve the tensile strength of the substrate to help prevent it from ripping when it is removed. A release coating may also be applied to the top side to facilitate removing tape from a roll.

Such masking tape is typically manufactured in relatively wide sheets that may be cut into narrow widths, such as one inch, and then fed to a rewinder for rolling onto a number of cores to form rolls.

It has become increasingly common to apply a curable coating, such as a polyurethane, to an exposed surface such as a wall, floor or automobile body to offer protection against, for example, corrosion, moisture and abrasion. These coatings are often applied by spraying, rolling or painting the coating material on to the surface to be protected, and allowing the coating material to dry or cure in place.

Applying such a rapidly drying or curing mixture to a surface to be protected permits a quick and relatively uniform application of the coating material to the entire surface and shortens the time required before the coated surface may be put to its normal or intended use. However, the coating must be applied relatively quickly, and applying the mixture by spraying, rolling or painting often requires masking those areas of the surface that are not intended to be coated before application of the coating, to protect those areas from unwanted coating material. Subsequent trimming of the coating material is common to remove unwanted coating material after the coating is applied, either to provide access to the areas that ought not to be coated, such as drains or electrical outlets, or to provide a neat appearance.

One particularly useful application is the increasingly common use of spray-on coatings for liners of boxes of pick-up trucks, and interiors of vans and trucks. This application is one in which the appearance of both the coated and uncoated surfaces is particularly important, and one in which a significant amount of masking may be required. Such a spray-on liner provides protection against the corrosive elements in the atmosphere and also against the abrasion caused by various materials that may be carried in the truck, van or box.

These spray on linings have several advantages over the more conventional protection afforded by premoulded plastic liners that are inserted into the box of a pickup truck. Premoulded plastic liners do not form a water-tight seal with the body of the truck, and permit the entry of water and dirt between the liner and the truck body. This may result in substantial abrasion and corrosion to the body of the truck which is, however, not visible through the opaque liner. The loose fit of the liner results in movement of the liner against the body of the truck, increasing the abrasion damage to the truck body.

Spray-on linings, however, provide a coating, typically of polyurethane, that is tightly bonded to the truck body, and which does not permit the entry of dirt or moisture between the lining and the truck body. Also, the flexible properties of the polyurethane coating offer a slip resistant as well as protective surface for the cargo to ride on. In the case of a lining for a pick up truck box, the lining is generally applied to the floor and side walls of the box and to some portion of the top rails and side body. It is important to provide a neat edge along the perimeter of the box. The rear of the box is generally masked to avoid applying any coating to the hinges and latching mechanism, and the tail gate is generally removed and the surface facing into the box of the pickup truck is coated separately. Both this surface, and the ends of the side and bottom surfaces of the box must be trimmed to permit proper opening and closing of the door as well as providing a neat appearance.

As in the case of painting or other surface applications, the surface area that is actually covered by the sprayed on material may be determined by masking the surface that is not intended to be covered with masking tape. The material to be sprayed on the surface is intended to adhere firmly to the surface. The use of masking materials prevents contact between those portions of the surface that are not intended to be covered, and allows the rapid application of the material only to the surface which is intended to be covered. These operations generally employ masking tape having an adhesive coating that is sufficiently strong to hold the masking material in place while it is intended to be there, and yet permit the easy removal of the masking material when it is no longer required, while leaving no significant amount of adhesive material on the surface to be protected. The use of the term adhesive throughout this application generally refers to a removable adhesive having these general properties.

After the application of the coating material, however, some trimming is required to remove the coating material. This is commonly done by cutting the coating material along the boundary of the masked area, to separate the coating that is to remain in place, and which will be firmly bonded to the surface, from the coating material that is to be removed, which should not have contacted the surface and which should be separated from the surface by the masking material. Once this separation is made, it is possible to remove the masking tape, and the unwanted surface coating. It is thus important in such a trimming application to cut precisely along the edge of the masking material so that no masking material is left on the surface beneath the coating. This would result in a portion or area of coating material that is not adhered to the surface to be protected, which could subsequently result in the peeling of the protective coating from the surface. Conversely, if the cut is away from the masked edge and into the area which is intended to be coated, removal of the coating from the masked area will be more difficult and may result in the removal of paint from the truck body.

One difficulty posed by the use of the relatively thick, abrasion-resistant coatings, such as polyurethane coatings, is the difficulty in locating the edges to be trimmed. Furthermore, while the removal of masking material used in painting effectively acts as an edge trimming method, tearing or cutting the paint layer as the masking material is removed, conventional masking materials will not tear through the polyurethane coating, and often cannot be located under the relatively thicker coatings of polyurethane such as those used to line a truck box.

Various methods have been developed to overcome this difficulty. For example, several layers of masking tape may be used and layers removed sequentially so that each layer of masking tape removes individual thin layers of the coating material before the coating begins to cure. This procedure generally requires extra personnel, is a time-consuming method that leaves a relatively rough edge to the coating material as well as an inferior bond at the extreme edge of the coating.

The most common way of trimming such coatings is simply by cutting the coating along the edge of the masking material with a knife or other sharp instrument. This requires, first of all, locating the edge of the masking material, and then cutting the protective coating with a sharp instrument such as a knife. This almost invariably has the result of cutting or scoring the underlying surface, which is a particular problem with painted surfaces such pick-up truck beds and requires that the line cut or scored into the truck bed to be repainted before the vehicle can be delivered to the consumer.

An improved approach employs the use of filament-bearing masking tape, which is described, for example, in U.S. Pat. Nos. 6,284,319, 6,875,469 and 7,014,900. These describe tape where a filament is embedded longitudinally between two equal width portions of a folded Pressure Sensitive Adhesive (PSA) tape. Such PSA tape has adhesive applied to the lower surface of the tape, which is uniform. A cutting filament is releasably secured to these tape products by one of two methods. One method is to envelope the filament by wrapping/folding the adhesive tape around the filament. The other is to embed the filament in an adhesive layer on one of the surfaces of the tape.

One of the problems with prior art filament-bearing masking tape formed by such methods is that the cutting filament must be pulled through the adhesive tape carrier before it begins to cut the desired coating or film, which causes additional strain on the filament.

The problem discussed below associated with adhering a fine filament to other prior art (e.g. Langeman WrapCut™ or 3M-Knifeless™) single-sided (adhesive coating on one side) tapes for trimming coatings and thin films whereby the filament is attached to the tape carrier by embedding the filament, wholly or in part, in the adhesive layer. In such case the application of a metal wire filament presents a major problem for the filament to remain in a fixed position on the tape while applying to a surface around corners and bends. Where a metal wire filament is preferred, it is much easier to adhere a synthetic fiber filament due to the ability of the adhesive to hold onto the fiber in its intended position, having a textured or irregular surface.

A major problem with prior art filament-bearing tape products is that the cutting filament is more or less limited to the use of a synthetic thread. The best filament for cutting through coatings and films has proven to be the smallest diameter metal wire having enough tensile strength to cut through the desired coating or film. Because of the difficulty associated with securing a metal filament to such PSA tapes, it has become most common to use a synthetic fiber filament, such as a Kevlar® thread that has a small enough diameter and enough tensile strength to cut through many polymeric films to produce an acceptable edge. However, the cut produced with a synthetic fiber thread is inferior to the cut produced with a small diameter metal wire.

The problem with trying to attach a fine diameter metal wire, or any metal wire, to a tape is that the wire tends to become dislodged from the adhesive tape or move from the intended position on the tape when trying to bend the tape around corners. Simply pulling the filament-bearing adhesive tape tightly in a straight line can dislodge the wire unintentionally, one of the reasons being that the wire does not have any elongation in comparison to the adhesive tape.

The use of filament-bearing tape is not limited to masking and can be used for applications where a coating is not being applied and where the purpose is not to protect an area from being coated but as below.

When used for vehicle wrapping or the application of a film to a window surface, the filament tape serves the purpose of defining the trim line prior to applying the film and becomes a cutting means, eliminating the use of a knife whereby a filament is pulled from the tape so as to cut the overlying material without damaging the surface that is to be covered by the coating or material.

### BRIEF DESCRIPTION OF THE DRAWINGS

FIG. 1 is a top perspective view of an embodiment of a foam tape with a cutting filament encompassed by the foam carrier with an adhesive coating on the lower side.

FIG. 2 is an end view of the tape of FIG. 1.

FIG. 3 is an end view of the tape of FIG. 1 further including a release coating on the upper side.

FIG. 3a is an end view of the tape of FIG. 1 further including adhesive on the upper side and a release liner applied over the top of the adhesive.

FIG. 4 is a top perspective another embodiment of a foam tape with a serrated profile upper surface and a cutting filament encompassed by the foam carrier and an adhesive coating on the lower side.

FIG. 5 is an end view of the tape of FIG. 4.

FIG. 6 is an end view of the tape of FIG. 4 further including multiple cutting filaments encompassed in the foam and multiple reinforcement filaments embedded in the foam.

FIG. 7 is an end view of the tape of FIG. 4 adhered to a surface where a film has been applied over the surface and the tape, where the filament has been removed from the tape, cutting through the film.

FIG. 8 is an expended view of a portion of FIG. 7 showing the break in the coating caused by removal of the cutting filament.

FIG. 9 is an end view of the tape of FIG. 4 with a masking film attached to the top of the tape, where the tape is adhered to a surface, a coating has been applied over the surface and the tape, and the filament has been removed from the tape, cutting through the coating.

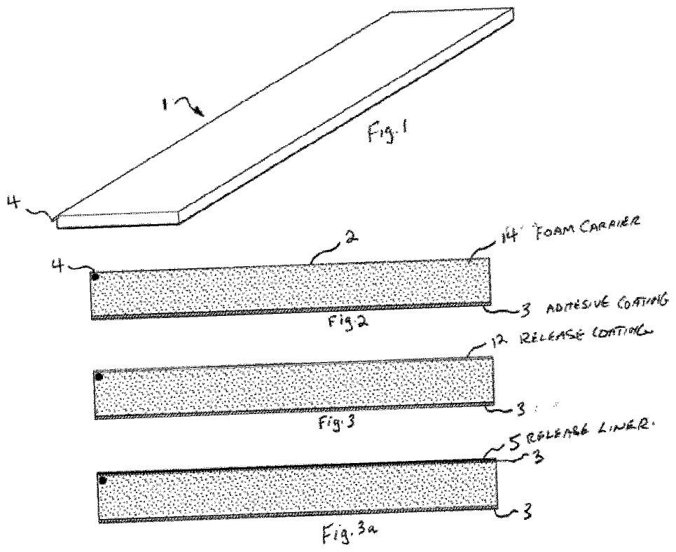

### DESCRIPTION OF THE INVENTION

The present invention is a new form of edge trimming tape that is well suited for trimming coatings, such as polyurethane, paint and epoxies; films such as vinyl and polyester, in addition to other various substrates such as paper, cork, felt, etc.

The following elements are numbered in the drawings.

Item no. 1: Extruded Profile with Releasably Secured Cutting Filament—Flexible Cellular Foam. The profile may be square or round or any other shape. This may alternatively be referred to as a substrate or carrier, which may comprise polyethylene foam or other foamed elastomeric compound. The tape preferably utilizes a foam rubber carrier (such as EVA foam—a polymer of Ethylene Vinyl Acetate) or Polyethylene Foam within which a filament is releasably encompassed or incorporated. The foam rubber carrier is thicker than the filament and has physical properties that enable the carrier to more easily conform to irregular surfaces and bend laterally and axially, along and around smaller diameter radiuses and compound curves significantly better than prior art tapes. The carrier may be manufactured as an extruded film of foamed polymeric material with a square profile that is designed to be held in a machined groove or it may have a rectangular profile with an adhesive on one or more surfaces, similar to single-coated or double-coated foam tape. The substrate may be made from natural or synthetic rubber or silicone rubber. The carrier is stretchable and compressible with a thickness greater than the filament. The thickness of the carrier may typically be 20 to 30 mils (0.020 to 0.030 inches or 0.050 to 0.075 cm). The unique flexibility of foam due to its physical properties provides a stretchable and compressible carrier and solves the problem of positioning the filament-bearing tape laterally on a surface around tight bends and acute angles. The high elongation of the foam also contributes to an increased effectiveness of the pressure sensitive adhesive (PSA) to hold the filament-bearing carrier flat to a surface where tight bends are made.

Item no. 2: Uncoated Surface of Extrusion—The extrusion may be made without an adhesive or release coating.

Item no. 3: Pressure Sensitive Adhesive (PSA) Coating—In preferred embodiments, where the tape may be used as a masking tape, the tape includes adhesive on the bottom side of the substrate. The adhesive may comprise acrylic adhesive. The adhesive may be a rubber or silicone adhesive. It may be, for example, about 1 mil (0.001 inches or 0.0025 cm) thick, comprising acrylic adhesive. In other embodiments, adhesive may be applied to both the top and bottom surfaces of the substrate and a release liner applied to one or both adhesive layers.

Item no. 4: Cutting Filament—The filament may be, for example, a 0.010 inch (0.025 cm) diameter metal wire cutting filament. In preferred embodiments, the size may range from 0.002 inch (0.0051 cm) diameter to 0.020 inch (0.051 cm) diameter. In some embodiments, the filament may be made of an elastic synthetic material, such as a monofilament nylon wire. In some embodiments, the filament may be a braided thread made from a plurality of fine strands. The material and thickness of the filament are selected based on the application for which the associated tape is intended to be used, such that the filament has sufficient tensile strength to cut the coating material or film it is intended to be used with when such coating is dried or cured. In preferred embodiments, the filament does not protrude beyond the carrier surface so that the finished product has a uniform flat surface across the entire width permitting the typical rewind process onto a paper core or spool without the problems associated with an irregular surface created by the filament being held on the surface of the carrier instead of within the surface of the carrier. In reference to rewinding the tape onto a spool, a key advantage of a uniform profile, whereby the tape does not have a filament attached to the exterior of the carrier, of this invention is that it provides for a level winding of the tape onto a roll, eliminating the difficulty of rewinding the tape in either a flat or traverse wound method on a core or spool.

Item no. 5: Release Liner—The release liner is a thin layer made from material selected to be readily removable after contact with an adhesive.

Item no. 6: Serrated Profile—A means for self-winding the extrusion in roll form whereby the adhesive coating on the opposite (bottom) side will not stick to the top side. As will be evident to skilled persons, many profiles could be made to achieve the same result.

Item no. 7: Reinforcement Filaments—For the purpose of increasing the tensile and tear strength of the extrusion without significant loss of flexibility.

Item no. 8: Film—illustration of film being layered over the extrusion and cut by pulling the filament upwards and through the film.

Item no. 9: Application Surface—The surface to which the film is being applied.

Item no. 10: Coating—Illustration of a coating applied to a surface and being cut by pulling the filament upwards through the coating.

Item no. 11: Masking Film—Additional masking film applied to the back (top surface) of the extrusion used to protect the surface not to be coated.

Item no. 12. Release Coating—A silicone or other release coating applied to the top (upper) surface of the foam tape carrier.

Item no. 14. Foam Carrier.

The new invention allows for the filament 4 to be encompassed by, or embedded in or enveloped by, the substrate and releasably held in place by the extruded material without preventing the removal of the filament 4 when pulled upwards and through the material 8, 10 to be cut. Preferably the substrate substantially surrounds the filament other than possibly a small portion of the filament, and holds the filament in position by substantially encapsulating the filament within the substrate material. The filament may be positioned within the carrier during the extrusion process of manufacturing the film/substrate or in a post-extrusion process in which the filament is incorporated in the substrate and encompassed by it.

The filament may be incorporated within the substrate at the moment of extrusion. Alternatively, as will be evident to one skilled in the art, a suitable film could be used and in a secondary process, the filament 4 incorporated by forming a cavity in the film and afterwards incorporating the filament 4 or by cutting an opening in the surface of the film and as a secondary process, inserting the filament 4 into the film substrate.

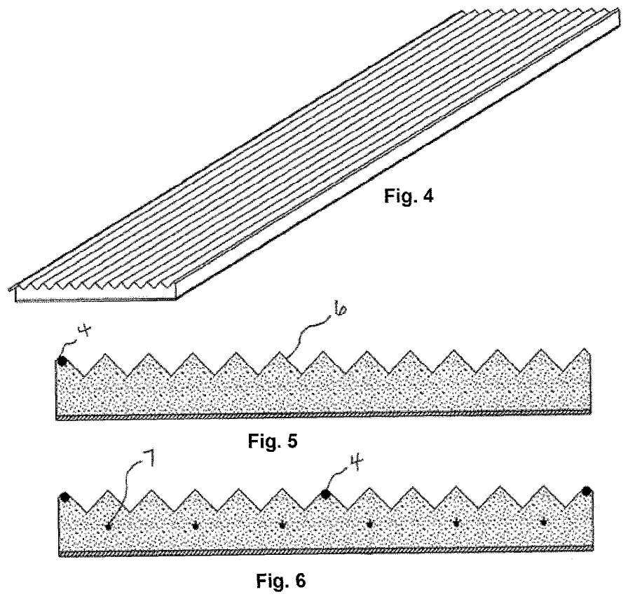

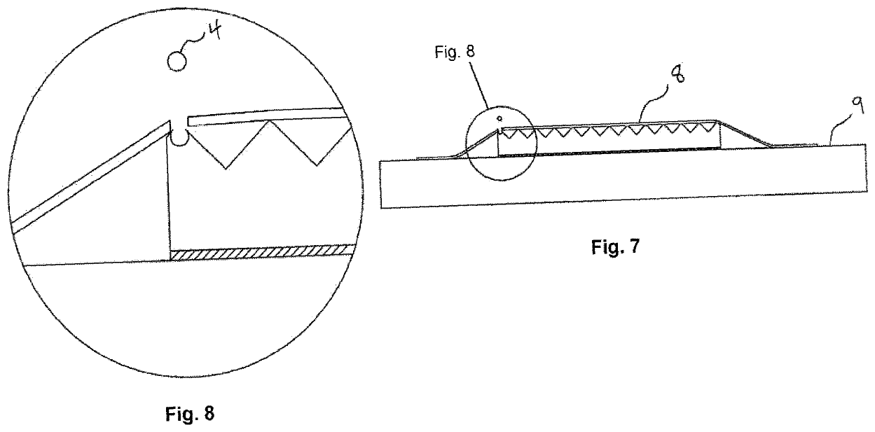

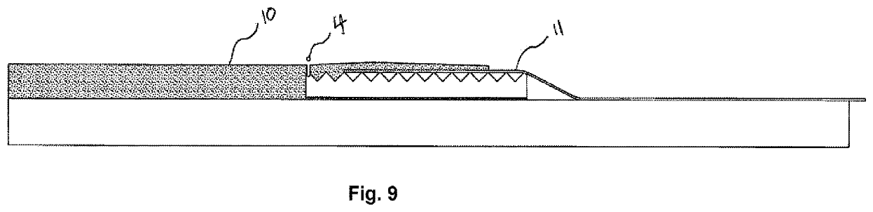

It is preferred to form the top surface of the extrusion 6 with a profile that decreases the surface area such as the embodiment shown in FIGS. 4-9 that has a serrated profile 6. Not only does such a profile permit self-winding without a release coating on the top surface, but it also improves the flexibility of the product.

The filament 4 is shown as being slightly exposed such that a minimum force is required for release of the filament 4 from the extrusion. In some embodiments, the filament is coated so that it is not bonded to the extrusion material.

An extruded film has other advantages in being able to use multiple filaments positioned precisely within the extrusion, for example as shown in FIG. 6. The width and thickness of the extrusion are also important advantages over the use of a PSA tape product.

It is key to the invention that the cutting filament is releasably retained within or releasably held by the substrate (carrier) itself without the use of an adhesive or other means of holding the filament in place. The filament may not be completely enveloped to be retained or held in place but in some embodiments it may be totally engulfed by the substrate.

In prior art filament-bearing masking tapes, a cutting filament is applied to and positioned upon a surface, and an adhesive is used in one way or another to hold the filament within or against the carrier. In some prior art as discussed above, the filament is enveloped within the adhesive and carrier by folding the adhesive tape around the filament. In prior art filament-bearing masking tape, the cutting filament is held in place by partially or completely embedding the filament in the adhesive.

The new invention relies on the carrier itself being thick enough to substantially surround the filament. The invention may also be made by making a cut into the surface of foam tape and inserting a cutting filament, although this is not preferred. For example, such a method would be especially difficult if one wanted to use a rubber carrier or similarly flexible carrier.

In the manufacture of the invention, the method of making the cooling/forming roll with a serrated surface with fine v-grooves, grooves serve two purposes. The first is to guide the filament in a precise position in the bottom of the “V” and the second is to allow the extruded molten material from the extruder to flow over and substantially around the filament so as to retain the filament within the rapidly cured substrate. Preferably, the filament is slightly exposed beyond the outer surface of the substrate for easy removal, but only slightly exposed so that the final product still has a flat, level top and bottom surface for rewinding on a roll without having to work with rewinding a substrate with an irregular surface. The cutting filament of prior art cutting filament tape inventions creates an uneven and irregular surface because the filament is held on the outside surface of the carrier substrate.

The new invention addresses the main issue that exists in cutting vinyl and other polymeric films. There is nothing better than using a fine, small diameter metal wire to make clean smooth cuts through the film. However, it is very difficult to attach a fine metal wire to a very thin adhesive coating on a thin tape substrate, especially when using double-side (coated) tape is not practicable for the application. It is much easier to attach a fiber filament, such as a Kevlar thread. The 3M product referred to as Knifeless Tape™ is related to patents on the positioning of a (fiber) filament adhesively retained at or near the center of the bottom, adhesive side of the tape so that the thin flexible tape carrier can be applied and positioned around curves whereby the tape can be bent similarly for inside and outside curves.

The limitations of typical prior art adhesive tapes include the relative lack of ability to apply and curve the tape on a flat surface while trying to facilitate curves and bends. The edges of the tape tend to buckle or pucker and lift away from the surface if the curve is too tight for the tape. That is easily demonstrated when attempting to apply masking tape on a flat surface while trying to make the tape adapt to a curve or bend. The new invention described herein does not rely on the location of the filament for making tight inside or outside turns but instead relies on the substrate having the ability to stretch and compress without the adverse effect of the carrier lifting away from the surface while bending the substrate around curves. The new invention, having a cellular foam carrier holds the advantage of accomplishing superior positioning ability over most single and double-coated adhesive tapes that do not incorporate a foam substrate carrier.

The invention also provides the ability to extrude almost any profile imaginable around the cutting filament. Another use for the invention is to make a profile that does not necessarily require the application of an adhesive to its surface. In the mold industry where parts are cast in a closed mold, there is typically an extra material referred to as flash around the perimeter of the molded part. The flash is the material that is allowed to escape the mold when completely filled. It is another use of the invention to machine a groove along the outer perimeter of the mold surface in which can be placed a strip of the extruded profile containing a cutting filament. Many parts such as automotive dashboards and seating products have a flashing that must be trimmed after removing from the mold. By having a cutting filament positioned along the precise trim line of the flashing, it is practical to pull the cutting filament from the groove to cut and remove the flash material. The filament-bearing silicone rubber extrusion with a profile that matches the groove prevents any of the molded material from entering the positioning groove during the molding process and would then be replaced with each cycle of use.

In a manufacturing process such as trimming a coating applied to a surface such as an automobile surface, the manufacturer of the automobile may design the area to be coated with a recess along the perimeter for the purpose of holding the filament carrier in place.

The present tape is novel in that the cutting filament does not rely on an adhesive means for attaching or effectively holding the filament to the carrier but instead utilizes the carrier to incorporate the filament within itself by encompassing or partially encompassing the filament.

The new invention is ideally suited for incorporation of a small diameter metal filament because the metal wire can be effectively held securely in place. In contrast, in prior art tapes, attempting to hold any filament securely in place on the typical PSA tape carrier by means of imbedding the filament partially or completely in the adhesive layer continues to be a problematic factor of such embodiments.

Another feature of the invention is the use of relatively soft, low-tensile strength cellular foam as the carrier whereby the user can easily access and remove the cutting filament by peeling back the foam from the filament using only their fingers, eliminating the requirement of a special tool or cutter.

The invention is also ideally suited to hold a synthetic fiber as a cutting means and is a preferable means of doing so over the prior art.

Another feature of the invention is that the cutting filament does not cause the carrier to lift from the surface when the filament is pulled for the purpose of cutting the coating or film. The invention shows that the filament is positioned within the top side of the carrier so that the carrier remains attached to the surface and does not instantly lift from the surface as the filament is pulled.

When the cutting filament is pulled from any of the existing products/art, the filament must either be pulled through the carrier that holds the filament in place or the filament must be pulled around the edge of the carrier, both methods producing a significant strain on the cutting filament to escape before starting to begin cutting the film or coating and causing the tape substrate to lift or deflect and thereby causing the film or coating to lift or deflect prior the final cut being completed. The present invention provides a means of the filament being in physical contact with film or coating for a more efficient and clean cutting process that does not disturbs or lift the film or coating during the cutting process.

It should be understood that the above-described embodiments of the present invention, particularly, any “preferred” embodiments, are only examples of implementations, merely set forth for a clear understanding of the principles of the invention. Many variations and modifications may be made to the above-described embodiment(s) of the invention as will be evident to those skilled in the art. That is, persons skilled in the art will appreciate and understand that such modifications and variations are, or will be, possible to utilize and carry out the teachings of the invention described herein.

Where, in this document, a list of one or more items is prefaced by the expression “such as” or “including”, is followed by the abbreviation “etc.”, or is prefaced or followed by the expression “for example”, or “e.g.”, this is done to expressly convey and emphasize that the list is not exhaustive, irrespective of the length of the list. The absence of such an expression, or another similar expression, is in no way intended to imply that a list is exhaustive. Unless otherwise expressly stated or clearly implied, such lists shall be read to include all comparable or equivalent variations of the listed item(s), and alternatives to the item(s), in the list that a skilled person would understand would be suitable for the purpose that the one or more items are listed.

The words “comprises” and “comprising”, when used in this specification and the claims, are used to specify the presence of stated features, elements, integers, steps or components, and do not preclude, nor imply the necessity for, the presence or addition of one or more other features, elements, integers, steps, components or groups thereof.

The scope of the claims that follow is not limited by the embodiments set forth in the description. The claims should be given the broadest purposive construction consistent with the description and figures as a whole.

1. A filament-bearing tape extending longitudinally and comprising a filament and a flexible substrate having a first edge and a second edge parallel to the first edge, and having top and bottom surfaces, wherein the filament is encompassed in the top surface of the substrate, parallel to the edges of the substrate.

2. The filament-bearing tape of claim 1, wherein the bottom surface of the substrate is coated with an adhesive.

3. The filament-bearing tape of claim 1, wherein the flexible substrate is a foamed elastomeric compound.

4. The filament-bearing tape of claim 3, wherein the flexible substrate is flexible cellular foam or polyethylene foam.

5. The filament-bearing tape of claim 1, wherein the flexible substrate is natural or synthetic rubber or silicone rubber.

6. The filament-bearing tape of claim 1, an upper surface of the filament not covered by the substrate so that the upper surface is exposed without extending above adjacent portions of the upper surface of the substrate.

7. The filament-bearing tape of claim 1, wherein an upper surface of the filament is minimally covered by a thin portion of the top surface of the substrate.

8. The filament-bearing tape of claim 1, wherein the top surface of the substrate has a profile configured to decrease the area of the top surface contacting a flat lower surface of a film or tape when the film or tape is placed over the top surface of the substrate.

9. The filament-bearing tape of claim 8, wherein the top surface of the substrate has a serrated profile.

10. A roll of the filament-bearing tape of claim 1.

11. A filament-bearing tape extending longitudinally comprising a filament and a flexible substrate comprising extruded material, and having a first edge and a second edge parallel to the first edge, and having top and bottom surfaces, wherein the filament is embedded in the substrate, parallel to the edges of the substrate, and proximate to the top surface of the substrate so that the filament is releasably held in place by the substrate so as not to restrict the removal of the filament when the filament is pulled upwards and through the top surface of the substrate.

12. The filament-bearing tape of claim 11, wherein the bottom surface of the substrate is coated with an adhesive.

13. The filament-bearing tape of claim 11, wherein the flexible substrate is a foamed elastomeric compound.

14. The filament-bearing tape of claim 12, wherein the flexible substrate is a foamed elastomeric compound.

15. The filament-bearing tape of claim 13, wherein the flexible substrate is flexible cellular foam or polyethylene foam.

16. The filament-bearing tape of claim 11, wherein the flexible substrate is natural or synthetic rubber or silicone rubber.

17. The filament-bearing tape of claim 12, wherein the flexible substrate is natural or synthetic rubber or silicone rubber.

18. The filament-bearing tape of claim 2, wherein the flexible substrate is a foamed elastomeric compound.

19. The filament-bearing tape of claim 18, wherein the flexible substrate is flexible cellular foam or polyethylene foam.
